(19) United States
(12) Patent Application Publication
(10) Pub. No.: US 2014/0281854 A1
(43) Pub. Date: Sep. 18, 2014

(54) HYPERMEDIA REPRESENTATION OF AN OBJECT MODEL

(71) Applicant: Comcast Cable Communications, LLC, Philadelphia, PA (US)

(72) Inventors: Michael Bevilacqua-Linn, Philadephia, PA (US); Jonathan Moore, Philadephia, PA (US); Ilirjan Papa, Drexel Hill, PA (US)

(73) Assignee: Comcast Cable Communications, LLC, Philadelphia, PA (US)

(21) Appl. No.: 13/828,056

(22) Filed: Mar. 14, 2013

(51) Int. Cl. G06F 17/22

(52) U.S. Cl. CPC G06F 17/2235
USPC 715/205

(57) ABSTRACT

A method and system may allow for converting an object model. For example, a computing device may receive an object model to be converted to a document that represents the object model. The computing device may be configured to traverse the object model and build a document (e.g., an XHTML document, XML document, etc.) that represents the object model. The document may comprise a series of tags that represent objects in the object model. The computing device may then provide the document as a part of a hypermedia API.

Data organization has become a complex problem in over modern day networks. For example, exposing a hypermedia application programming interface (API) to one or more devices may not be feasible with an object oriented data model. Accordingly, there is a need for converting an object model into a compatible format.

In addition, the compatible format may need to be converted back into an object oriented data model at a device that, for instance, invoked a hypermedia API call. Accordingly, and in some instances, a conversion and a subsequent reconversion may be useful in providing a hypermedia API.

### SUMMARY

The following summary is for illustrative purposes only, and is not intended to limit or constrain the detailed description.

In some embodiments, a computing device may provide one or more methods for generating a document representation of an object model, such as by, converting an object model into a hypermedia document. The computing device may be configured to traverse the object model and build a document (e.g., an XHTML document, XML document, JSON document, etc.) that represents the object model. The computing device may then expose the document to one or more user devices as a part of a hypermedia application programming interface (API).

In some embodiments, a tag may be created for each object in an object data model. For example, the tag may comprise an XHTML <div> tag. In this embodiment, one or more tags may comprise a unique object id. Each object may be represented by a corresponding tag. In exemplary embodiments, one or more links between a tag for an object and a unique object id for another object may be created based on object references in, for example, the object model. In some examples, the links may comprise one or more <a> XHTML tags. One or more attributes for objects may be represented by <span> XHTML tags.

In some embodiments, a service provider may send a created document to one or more user devices. The one or more user devices may be configured to build an object model based on the received document. For example, the received document may be parsed, and one or more objects may be created based on the parsed document, where the created objects may comprise an object model.

In some embodiments, the created objects may be based on one or more XHTML <div> tags in the received document. Objects may be defined by <span> tags that define attributes for an object and <a> tags that define references to other objects. Instances of objects may be created based on each <div> tag included in the received document.

As noted above, this Summary is merely a summary of some of the features described herein. It is not exhaustive, and it is not to be a limitation on the claims. Further embodiments are described below.

### BRIEF DESCRIPTION OF THE DRAWINGS

Aspects of the present disclosure are described by way of example with respect to the accompanying figures in which like numerals indicate similar elements.

FIG. 1 illustrates an example communication network according to one or more embodiments.

FIG. 2 illustrates an example computing device according to one or more embodiments.

FIG. 3 illustrates an example object model according to one or more embodiments.

FIG. 4 illustrates an example process converting an object model into a document representing the object model according to one or more embodiments.

FIG. 5 illustrates an example process for building a document that represents an object model according to one or more embodiments.

FIG. 6 illustrates an example process for building an object model according to one or more embodiments.

FIG. 7 illustrates an example process for building an object model based on a document according to one or more embodiments.

FIG. 8 illustrates an example object model according to one or more embodiments.

FIG. 9 illustrates an example computing device according to one or more embodiments.

### DETAILED DESCRIPTION

In the following description, reference is made to the accompanying figures, in which are shown various illustrative embodiments. It is to be understood that other embodiments may be utilized and structural and functional modifications may be made, without departing from the scope of the present disclosure.

FIG. 1 illustrates an example network 100 on which many of the various features described herein may be implemented. Network 100 may be any type of information distribution network, such as satellite, telephone, cellular, wireless, etc. One example may be an optical fiber network, a coaxial cable network, or a hybrid fiber/coax, wired, and/or wireless distribution network. Communication network 100 may include interconnected communication links 101 (e.g., coaxial cables, optical fibers, wireless, etc.) to connect multiple user device(s) located at premises 102 (e.g., businesses, homes, consumer dwellings, etc.) to a central communication system 103 (e.g., headend, central office, etc.). The central communication system 103 may transmit downstream information signals onto the links 101, and each premises 102 may have a receiver used to receive and process those signals.

There may be one link 101 originating from the central communication system 103, and it may be split a number of times to distribute the signal to various user devices at premises 102 in the vicinity (which may be many miles) of the central communication system 103. The links 101 may include components not illustrated, such as splitters, filters, amplifiers, etc. to help convey the signal clearly, but in general each split introduces a bit of signal degradation. Portions of the links 101 may also be implemented with fiber-optic cable, while other portions may be implemented with coaxial cable, other lines, or wireless communication paths. By running fiber optic cable along some portions, for example, signal degradation may be significantly minimized, allowing a single local office 103 to reach even farther with its network of links 101 than before.

The central communication system 103 may include an interface, such as interface 104. More specifically, the interface 104 may be a cable modem termination system (CMTS), which may be a computing device configured to manage communications between devices on the network of links 101 and backend devices such as servers 105-107 (to be discussed further below). For example, central communication system 103 may be a service provider that provides Internet service to user device(s) at premises 102. The interface 104 may be as specified in a standard, such as the Data Over Cable Service Interface Specification (DOCSIS) standard, published by Cable Television Laboratories, Inc. (a.k.a. CableLabs), or it may be a similar or modified device instead. The interface 104 may be configured to place data on one or more downstream frequencies to be received by modems at the various premises 102, and to receive upstream communications from those modems on one or more upstream frequencies.

The central communication system 103 may also include one or more network interfaces 108, which can permit the central communication system 103 to communicate with various other external networks 109. These networks 109 may include, for example, networks of Internet and/or Internet devices, telephone networks, cellular telephone networks, fiber optic networks, local wireless networks (e.g., WiMAX), satellite networks, intranets, and/or any other desired networks, and the network interface 108 may include the corresponding circuitry needed to communicate on the external networks 109, and/or to other devices on these networks such as a cellular telephone network and its corresponding cell phones.

As noted above, the central communication system 103 may include a variety of computing devices 105-107 that may be configured to perform various functions. For example, computing device 105 of central communication system 103 may comprise a push notification server. The push notification server may generate push notifications to deliver data and/or commands to the various user device(s) at premises 102 in the network (or more specifically, to user device(s) at premises 102 that are configured to detect such notifications). The central communication system 103 may also include computing device 106, which may comprise a content server. The content server may be one or more computing devices that are configured to provide content to users at their premises. This content may be, for example, video on demand movies, television programs, songs, text listings, etc. The content server may include software to validate user identities and entitlements, to locate and retrieve requested content, to encrypt the content, and to initiate delivery (e.g., streaming) of the content to the requesting user(s) and/or device(s).

The central communication system 103 may also include one or more computing device(s) 107, which may comprise application servers. An application server may be a computing device configured to offer any desired service, and may run various languages and operating systems (e.g., servlets and JSP pages running on Tomcat/MySQL, OSX, BSD, Ubuntu, Redhat, HTML5, JavaScript, AJAX and COMET). For example, an application server may be responsible for collecting television program listings information and generating a data download for electronic program guide listings. Another application server may be responsible for monitoring user viewing habits and collecting that information for use in selecting advertisements. Yet another application server may be responsible for formatting and inserting advertisements in a video stream being transmitted to user device(s) at premises 102. Although shown separately, one of ordinary skill in the art will appreciate that the computing devices 105-107 may be combined. Further, here the computing devices 105-107 are shown generally, and it will be understood that they may each contain memory storing computer executable instructions to cause a processor to perform steps described herein and/or memory for storing data.

An example premises 102a, such as a home, may include an interface 120. The interface 120 can include any communication circuitry needed to allow a device to communicate on one or more links 101 with other devices in the network. For example, the interface 120 may include a modem 110, which may include transmitters and receivers used to communicate on the links 101 and with the central communication system 103. The modem 110 may be, for example, a coaxial cable modem (for coaxial cable lines 101), a fiber interface node (for fiber optic lines 101), twisted-pair telephone modem, cellular telephone transceiver, satellite transceiver, local wi-fi router or access point, or any other desired modem device. Also, although only one modem is shown in FIG. 1, a plurality of modems operating in parallel may be implemented within the interface 120. Further, the interface 120 may include a gateway interface device 111. The modem 110 may be connected to, or be a part of, the gateway interface device 111. The gateway interface device 111 may be a computing device that communicates with the modem(s) 110 to allow one or more other devices in the premises 102a, to communicate with the central communication system 103 and other devices beyond the central communication system 103. The gateway 111 may be a set-top box (STB), digital video recorder (DVR), computer server, or any other desired computing device. The gateway 111 may also include (not shown) local network interfaces to provide communication signals to requesting entities/devices in the premises 102a, such as display devices 112 (e.g., televisions), additional STBs 112, personal computers 114, laptop computers 115, wireless devices 116 (e.g., wireless routers, wireless laptops, notebooks, tablets and netbooks, cordless phones (e.g., Digital Enhanced Cordless Telephone—DECT phones), mobile phones, mobile televisions, personal digital assistants (PDA), etc.), landline phones 117 (e.g. Voice over Internet Protocol—VoIP phones), and any other desired devices. Examples of the local network interfaces include Multimedia Over Coax Alliance (MoCA) interfaces, Ethernet interfaces, universal serial bus (USB) interfaces, wireless interfaces (e.g., IEEE 802.11, IEEE 802.15), analog twisted pair interfaces, Bluetooth interfaces, and others.

FIG. 2 illustrates an exemplary computing device 107 (e.g., an application server) configured to provide a hypermedia API according to some embodiments. Computing device 107 may be variously configured. The computing device 107 may include controller 201, builder 202, and one or more database(s) 203 which may either be internal and/or external to the computing device 107.

In some embodiments, computing device 107 may provide one or more methods for forming and/or converting an object model as a document. For example, controller 201 may receive an object model or an object model may be stored in one or more database(s) 203. Builder 202 may be configured to, for example, traverse the object model and/or build a document (e.g., an XHTML document, XML document, JSON document, etc.) that represents, for example, the object model. Controller 201 may then expose the document as a part of a hypermedia API. For example, computing device 107 (e.g., application server) may expose the created document as a part of a hypermedia API to one or more user devices (e.g., interface 118, modem 114, gateway 115, display device 112, set top box 114, personal computer 114, laptop computer 115, or wireless device 116) located at, for example, client premises 102(a). In response to a method call (e.g., an HTTP GET request), computing device 106 may send the document over network link(s) 101 to one or more of the user devices.

FIG. 3 illustrates an example object model according to an embodiment. For example, the object model may comprise of objects movie 301, director 302, and producer 303. As depicted, a movie 301 object may comprise of one or more director 302 objects and producer 303 objects. Movie 301 may also include one or more scalar attributes, such as a title. As depicted, director 302 objects may comprise of one or more movie 301 objects. Director 302 may also include one or more scalar attributes, such as a name. Producer 303 may comprise of one or more scalar attributes, such as a name and a location.

Exemplary instances of one or more objects in an object model according to an embodiment will be described. For example, a first object may be a director object according to director 302 and may comprise a name attribute, such as Steven Spielberg, and references to a second object comprising a movie object and a third object comprising a movie object. A second object may comprise a movie object according to movie 301 and may comprise a title attribute, such as Empire Strikes Back, and references to the first object comprising a director object and a fourth object comprising a producer object. A third object may comprise a movie object according to movie 301 and may comprise a title attribute, such as Return of the Jedi, and references to the first object comprising a director object and a fourth object comprising a producer object. A fourth object may comprise a producer object according to producer 303 and may comprise of a name attribute, such as Lucasfilm Ltd., and a location attribute, such as Marin County, CA. Each of the first, second, third and fourth objects may comprise a unique identifier, such as “obj1,” “obj2,” “obj3,” and “obj4” respectively.

Example processes of converting an object model and/or forming a document representative of an object model are described further below in FIGS. 4 and 5 with reference to FIGS. 1-3. In some embodiments, a subscriber (e.g., a user device at premises 102(a)) may subscribe to a service from a service provider (e.g., central communication system 103) where the service provider may provide cable, Internet, phone, a combination of these services, or any other suitable service to the subscriber. In an example, computing devices 105-107, located at a central communication system 103, may communicate with user device(s) at premises 102 (e.g., modem 110, gateway 111, and any of the associated devices 112, 113, 114, 115, 117, and/or 116) in order to provide media content, such as television shows, movies, streaming media, other media content.

In some embodiments, computing devices 107 (e.g., application server) may expose a hypermedia API to one or more user devices located at premises 102(a). For example, the hypermedia API may be a part of a service provided to one or more user devices located at premises 102(A). In order to expose an object model as a part of the hypermedia API, computing device 107 may convert the object model into a document that represents the object model (e.g., XHTML document, XML document, JSON document, etc.). This conversion may be performed, for example, in order to allow an object model to be reproduced at user device(s) located at premises 102(a).

FIG. 4 illustrates a process for converting an object model into a document representing the object model according to an embodiment. For example, computing device 107 may perform the steps associated with FIG. 4. Referring to FIG. 4, an algorithm for creating a document representative of an object model may begin at step 401. In step 401, an object model is received. For example, an object model may be received, an object model stored in database 203 may be referenced, and/or information sufficient to construct an object model as a document may be received.

The process of FIG. 4 may proceed from step 401 to step 402, where information associated with the object model is traversed. The traversal of the information associated with the object model may indicate a structure for the object model. In some embodiments, steps 402 and steps 403 may be performed concurrently. The process of FIG. 4 may proceed from step 402 to step 403, where a document is built that represents an object model. For example, a document may be built that represents the received object model based on the traversal performed in step 402. In some embodiments, steps 402 and 403 may be performed concurrently and may further comprise the process illustrated in FIG. 5.

FIG. 5 illustrates a process for building a document that represents an object model according to an embodiment. For example, FIG. 5 may perform a traversal of an object model and may further build a document (e.g. XHTML document) that represents the object model. FIG. 5 may begin at step 501, where a root object is placed on a to-visit list. For example, an object model may comprise the object model described above with reference to FIG. 3 comprising objects obj1, obj2, obj3, and obj4. When performing the steps of FIG. 5 on such an object model, a root node added to a to-visit list may be obj1 (e.g., a director object with the name “Steven Spielberg” and references to obj2 and obj3). In an embodiment, a to-visit list may keep track of the objects to be visited during a traversal.

The process of FIG. 5 may proceed from step 501 to step 502, where it is determined whether an object is on the to-visit list. For the above example, obj1 may be on the to-visit list based on step 501. The process of FIG. 5 may proceed from step 502 to step 503, where the first object on the to-visit list is taken. For the above example, obj1 may be taken based on the previous step 501. The process of FIG. 5 may proceed from step 503 to step 504, where it is determined whether the object is on the visited list. A visited list may track which objects may have already been visited during a traversal. For the above example, it is determined whether obj1 is on the visited list. Here, obj1 is not on the visited list, and the process of FIG. 5 accordingly proceeds from step 504 to step 505. If the object where on the visited list, the process of FIG. 5 would proceed from step 504 to step 510.

At step 505, a <div> tag with a unique identifier is created. The created <div> tag may be an XHTML <div> tag. For the above example, a <div> tag may be created for obj1 that includes the unique identifier “obj1.” A <div> tag, as described with reference to an embodiment, may represent a particular object in an object model (e.g., obj1). A <div> tag may further include scalar attributes for an object (e.g., as represented by <span> tags) and references to other objects (e.g., as represented by <a> tags). In some embodiments, a <div> tag may include an itemtype, which may describe the type of object that the <div> tag represents (e.g., director, movie, or producer). Accordingly, for obj1, a <div> tag may be created where an id for the <div> tag may equal “obj1” and an itemtype for the <div> tag may equal “director.”

The process of FIG. 5 may proceed from step 505 to step 506, where one or more <span> tags are created for each scalar property. A created <span> tag may be an XHTML <span> tag. For the above example, a <span> tag may be created for obj1 that includes the name “Steven Spielberg.” The <span> tag may further comprise an itemprop that describes the scalar attribute represented by the <span> tag. Here, the itemprop may equal “name.” In some embodiments, after each <span> tag is created, the <span> tag may be closed, for instance, by adding an XHTML </span> tag.

The process of FIG. 5 may proceed from step 506 to step 507, where one or more <a> tags are created for each reference to another object. A created <a> tag may be an XHTML <a> tag. For the above example, two <a> tags may be created for obj1 that reference obj2 and obj3. The <a> tag may further comprise an itemprop that describes the relationship between the objects. In the above example, obj1 comprises a director object and obj2 and obj3 comprise movie objects. Accordingly, the itemprop may equal “directed.” Each <a> tag may also comprise an href that defines the particular object references. In the above example, the two <a> tags created may include an href that equals “obj2” and an href that equals “obj3” respectively. In some embodiments, after each <a> tag is created, the <a> tag may be closed, for instance, by adding an XHTML </a> tag. In some embodiments, after the last <a> tag is created, a <div> tag may be closed, for instance, by adding an XHTML </div> tag.

The process of FIG. 5 may proceed from step 507 to step 508, where the objects referenced are put on a to-visit list if the referenced objects are not on a visited list. For example, referenced objects, such as those included in the <a> tags created in step 507, may be put on the to-visit list. In some embodiments, a references object may not be put on the to-visit list if the referenced object is already on the visited list. In addition, a reference object may not be put on the to-visit list if the reference object is already on the to-visit list. In the above example, obj2 and obj3 are referenced by obj1 and are not on the visited list or on the to-visit list. Accordingly, obj2 and obj3 may be put on the to-visit list.

The process of FIG. 5 may proceed from step 508 to step 509, where the object is placed on a visited list. For example, obj1 may be placed on the visited list to indicate that obj1 has already been visited during a traversal. The process of FIG. 5 may proceed from step 509 to step 510, where the object is removed from the to-visit list. For example, obj1 may be removed from the to-visit list.

The process of FIG. 5 may proceed from step 510 to step 511, where it is determined whether an object is on the to-visit list. In the above example, an iteration of obj1 added obj2 and obj3 to the to-visit list. Because there is an object on the to-visit list, FIG. 5 may proceed to step 503 and may repeat the steps 503-510, as previously described, for obj2.

In an example iteration over obj2, during steps 505-507 a <div> tag may be created with a <span> tag and two <a> tags. At step 508, obj4 may be added to the to-visit list because obj4 is referenced by obj2. At steps 509 and 510, obj2 may be added to the visited list and may be removed from the to-visit list. When arriving at step 511, it may be determined that objects remain on the to-visit list (e.g., obj3 and obj4), and the process of FIG. 5 may proceed to step 503 and may repeat steps 503-510 for obj3.

In an example iteration over obj3, during steps 505-507 a <div> tag may be created with a <span> tag and two <a> tags. At step 508, no new objects may be added to the to-visit list because the two objects referenced by obj3 (e.g., obj1 and obj4) may either be on the visited list or may already be on the to-visit list. At steps 509 and 510, obj3 may be added to the visited list and may be removed from the to-visit list. When arriving at step 511, it may be determined that objects remain on the to-visit list (e.g., obj4), and the process of FIG. 5 may proceed to step 503 and may repeat steps 503-510 for obj4.

In an example iteration over obj4, during steps 505-507 a <div> tag will be created with two <span> tags. At step 508, no new objects may be added to the to-visit list because obj4 does not include any referenced objects. At steps 509 and 510, obj4 may be added to the visited list and may be removed from the to-visit list. When arriving at step 511, it may be determined that no objects are on the to-visit list, and the process of FIG. 5 may proceed to step 511, where the process ends.

By way of example, the process of FIG. 5 may be performed on an object model that comprises obj1, obj2, obj3, and obj4, as previously described, and a document may be built that represents the object model. In some embodiments, the process of FIG. 5 may build an XHTML document similar to:

<html>

<body>

<div id=”obj1” itemscope=”1” itemtype=”director”>

<span itemprop=”name”>Steven Spielberg</span>
<a itemprop=”directed” href=”#obj2”></a>
<a itemprop=”directed” href=”#obj3”></a>

</div>
<div id=”obj2” itemscope=”1” itemtype=”movie”>

<span itemprop=”title”>Empire Strikes Back</span>
<a itemprop=”director” href=”#obj1”></a>
<a itemprop=”producer” href=”#obj4”></a>

</div>
<div id=”obj3” itemscope=”1” itemtype=”movie”>

<span itemprop=”title”>Return of the Jedi</span>
<a itemprop=”director” href=”#obj1”></a>
<a itemprop=”producer” href=”#obj4”></a>

</div>
<div id=”obj4” itemscope=”1” itemtype=”producer”>

<span itemprop=”name”>Lucasfilm Ltd.</span>
<span itemprop=”location”>Marin County, CA</span>

</div>

</body>

</html>

The process of FIG. 5 is a mere example implementation of steps 402 and 403 of FIG. 4, and any other suitable implementation may be substituted. For example, an XML or JSON document, or any other suitable document, may be created, any other suitable traversal algorithm may be performed, any other suitable tags may be created/substituted, etc. The process of FIG. 4 may proceed from step 403 to step 404, where the created document is provided. For example, the created document may be provided as a part of a hypermedia API that is exposed to one or more user devices.

In some embodiments, the created document is sent from central communication system 103 to one or more user device(s) located at premises 102(a). For example, the document may be sent so that a user device located at premises 102(a) may produce the object model represented by the document. The document may be sent in response to a method call (e.g., an HTTP GET request) to a hypermedia API. For example, the hypermedia API may be part of a service, such as a content service, provided to one or more user device(s) at premises 102(a). Computing device 107 (e.g., application server) may send the document so that content may be organized/listed appropriately by one or more user device(s) located at premises 102(a). Accordingly, one or more user device(s) located at premises 102(a) (e.g., modem 110, gateway 111, and any of the associated devices 112, 113, 114, 115, 117, and/or 116) may be configured such that an object model may be produced based on the received document.

FIG. 6 illustrates a process for building an object model according to an embodiment.

For example, one or more user device(s) located at premises 102(a) may perform the steps of FIG. 6. In an embodiment, a user device that comprises a hypermedia client (e.g., interface 118, display device 112, set top box 113, personal computer 114, laptop 115, or wireless device 116) may access a hypermedia API provided by central communication system 103 (e.g., computing device 107). The user device may communicate with the hypermedia API using one or more method calls (e.g., HTTP requests). In an embodiment, the user device may automatically discover the hypermedia API by vising the API homepage. From the homepage, one or more links and/or forms may be used to navigate the hypermedia API. In an example, the user device may navigate the hypermedia API until it invokes a method call (e.g., HTTP GET request) for a document that represents an object model.

The process of FIG. 6 may begin at step 601, where a document is received that represents an object model. For example, the document may be received from computing device 107 (e.g., application server) located at central communication system 103 in response to a method call (e.g., an HTTP GET request). In some embodiments, the document may comprise an XHTML document created by the process of FIG. 4. For example, the document may represent an object model comprising obj1, obj2, obj3, and obj4, as previously described.

The process of FIG. 6 may proceed from step 601 to step 602, where the received document is parsed. In some embodiments, a received XHTML document may be parsed based on tags (e.g., <body>, <div>, <span>, etc.) and/or attribute definitions in each tag (e.g., div id, itemtype, itemprop, href, etc.). In other embodiments, the received document may be formatted according to any other suitable format and may accordingly be parsed in a similar manner for that format.

The process of FIG. 6 may proceed from step 602 to step 603, where an object model is built according to the parsed document. For example, a document may be received that represents an object model that comprises obj1, obj2, obj3, and obj4, and the document may be parsed and subsequently used to build an object model that comprises obj1, obj2, obj3, and obj4. In some embodiments, step 603 may comprise the process illustrated in FIG. 7.

FIG. 7 illustrates a process for building an object model based on a document according to an embodiment. For example, FIG. 7 may build an object model based on a parsed document (e.g. XHTML document) that represents the object model. The process of FIG. 7 may begin at step 701, where unique itemtypes are determined from the parsed document. In some embodiments, the unique itemtypes may represent the different types of objects in the object model (e.g., director, movie, producer). Each object, as represented by each <div> tag, may include an itemtype (e.g., director, movie, producer).

In an example where the received document comprises an XHTML document that represents an object model for obj1, obj2, obj3, and obj4, as depicted above, the itemtypes for each object, as defined in the document, comprise director, movie, movie, and producer respectively. Accordingly, the unique itemtypes comprise director, movie, and producer.

The process of FIG. 7 may proceed from step 701 to step 702, where objects are defined for each unique itemtype. For example, an object may be defined by the <span> and <a> tags included in a <div> tag that represents that object. In the above example for an XHTML document that represents an object model that comprises obj1, obj2, obj3, and obj4, each of the itemtypes director, movie, and producer may be defined based on the <div> tags that represent each object.

For example, a <div> tag for an itemtype equal to “director” includes a <span> tag with the itemprop “name” and one or more <a> tags with reference to movie objects obj2 and obj3. Accordingly, a director object may include a name attribute and one or more references to movie objects.

In another example, a <div> tag for an itemtype equal to “movie” includes a <span> tag with the itemprop “title,” one or more <a> tags with reference to a director object obj1 and one or more <a> tags with reference to a producer object obj4. Accordingly, a director object may include a title attribute, one or more references to director objects, and one or more reference to producer objects.

In another example, a <div> tag for an itemtype equal to “producer” includes a <span> tag with the itemprop “name” and a <span> tag with the itemprop “location.” Accordingly, a producer object may include a name attribute and a location attribute.

The process of FIG. 7 may proceed from step 702 to step 703, where the first <div> tag is taken in the document. In an example where the received document comprises an XHTML document that represents an object model for obj1, obj2, obj3, and obj4, as depicted above, the first <div> tag includes a div id that equals “obj1.”

The process of FIG. 7 may proceed from step 703 to step 704, where an instance for an object represented by the <div> tag is created. An itemtype for the <div> tag may define the type of object to be created. In an example, the <div> tag with the div id that equals “obj1” comprises an itemtype equal to “director.” Accordingly, a director object is created for the <div> tag.

In some embodiments, a director object is created for the <div> tag according to the object definition created in step 702. For example, a director object includes a name attribute and one or more references to movie objects. Accordingly, a director object may be created based on the <div> tag with the div id equal to “obj1.”

The process of FIG. 7 may proceed from step 704 to step 705, where scalar attributes are added to the created object. For example, scalar attributes may be added based on one or more <span> tags included in a <div> tag. For the <div> tag with the div id equal to “obj1,” a scalar attribute name with the value “Steven Spielberg” is added to the created director object based on the <span> tag with the itemprop “name” equal to “Steven Spielberg.”

The process of FIG. 7 may proceed from step 705 to step 706, where references to other objects are added to the created object. For example, references to other objects may be added based on one or more <a> tags included in a <div> tag that represents the object. For the <div> tag with the div id that equals “obj1,” a reference to obj2 is added based on the <a> tag with the href equal to “obj2” and a reference to obj3 is added based on the <a> tag with the href equal to “obj3.” Accordingly, references to obj2 and obj3 may be added to the created director object.

The process of FIG. 7 may proceed from step 706 to step 707, where it is determined whether there is a next <div>. In an example where the received document comprises an XHTML document that represents an object model for obj1, obj2, obj3, and obj4, as depicted above, the next <div> tag includes a div id that equals “obj2.” Accordingly, the process of FIG. 7 may proceed to step 708, where the process moves to the <div> tag with the div id that equals “obj2.”

The process of FIG. 7 may repeat steps 704-706 for the <div> tag with the div id equal to “obj2.” For example, the <div> tag comprises an itemtype equal to “movie.” Accordingly, a movie object may be created for the <div> tag. The movie object may include a scalar attribute “title” of the value “Empire Strikes Back” based on the <span> tag with the itemprop “title” that equals “Empire Strikes Back” included in the <div> tag. The movie object may also include an object reference to obj1 and an object reference to obj4 based on the <a> tag with the href equal to “obj1” and the <a> tag with the href equal to “obj4” included in the <div> tag.

The process of FIG. 7 may proceed from step 706 to step 707, where it is determined whether there is a next <div>. In the above example, the next <div> tag includes a div id that equals “obj3.” Accordingly, the process of FIG. 7 may proceed to step 708, where the process moves to the <div> tag with the div id that equals “obj3.”

The process of FIG. 7 may repeat steps 704-706 for the <div> tag with the div id equal to “obj3.” For example, the <div> tag comprises an itemtype equal to “movie.” Accordingly, a movie object may be created for the <div> tag. The movie object may include a scalar attribute “title” of the value “Return of the Jedi” based on the <span> tag with the itemprop “title” that equals “Return of the Jedi” included in the <div> tag. The movie object may also include an object reference to obj1 and an object reference to obj4 based on the <a> tag with the href equal to“obj1” and the <a> tag with the href equal to “obj4” included in the <div> tag.

The process of FIG. 7 may proceed from step 706 to step 707, where it is determined whether there is a next <div>. In the above example, the next <div> tag includes a div id that equals “obj4.” Accordingly, the process of FIG. 7 may proceed to step 708, where the process moves to the <div> tag with the div id that equals “obj4.”

The process of FIG. 7 may repeat steps 704-706 for the <div> tag with the div id equal to “obj4.” For example, the <div> tag comprises an itemtype equal to “producer.” Accordingly, a producer object may be created for the <div> tag. The producer object may include a scalar attribute “name” of the value “Lucasfilms Ltd.” based on the <span> tag with the itemprop “name” equal to “Lucasfilms Ltd.” and a scalar attribute “location” of the value “Marin County, CA” based on the <span> tag with the itemprop “location” equal to “Marin County, CA” included in the <div> tag.

The process of FIG. 7 may proceed from step 706 to step 707, where it is determined whether there is a next <div>. In the above example, the <div> tag with the div id that equals “obj4” is the last <div> tag. Accordingly, the process of FIG. 7 may proceed to step 709, where the process ends.

The process of FIG. 7 is a mere example implementation of step 603 of FIG. 3, and any other suitable implementation may be substituted. For example, an XML document, or any other suitable document, may be received, any other suitable object model building algorithm may be performed, any other suitable tags may be leveraged, etc. The process of FIG. 6 may proceed from step 603 to step 604, where the created object model is stored. For example, the created object model may be stored locally at one or more user device(s) located at premises 102(a).

In some embodiments, the document may be received as an XHTML document and may subsequently be translated and parsed as an XML document. In such an embodiment, a process for creating an object model based on an XML document may be performed similar to the processes illustrated in FIGS. 6 and 7. In another embodiment, the document may be received as an XML document.

In some embodiments, the stored object model may be leveraged in order to provide content to a user of a user device located at premises 102(a). The object model may be used to organize and subsequently list content to one or more users. For instance, set top box 113 may receive the document and may subsequently generate an object model, as illustrated in FIGS. 6 and 7. The created object model may be used to display/list content (e.g., movies, tv-shows, etc.) to one or more users.

The object model illustrated in FIG. 3 and described with reference to obj1, obj2, obj3, and obj4 is a mere example, and any other suitable object model may be substituted. For example, an object model as illustrated in FIG. 8 may be used to by the processes of FIGS. 4-7.

FIG. 9 illustrates hardware elements that can be used to implement any of the various computing devices discussed herein. For example, a device such as computing device 900 may be used to implement server 105, server 106, server 107, terminal system 104, network interface 118, gateway 111, set top box 113, personal computer 114, laptop computer 115 or wireless device 126. The computing device 900 may include one or more processors 901, which may execute instructions of a computer program to perform any of the features described herein. The instructions may be stored in a computer-readable medium or memory, to configure the operation of the processor(s) 901. For example, instructions may be stored in a read-only memory (ROM) 902, random access memory (RAM) 903, removable media 904, such as a Universal Serial Bus (USB) drive, compact disk (CD) or digital versatile disk (DVD), floppy disk drive, or other removable storage medium. Instructions may also be stored in an attached (or internal) hard drive 905. The computing device 900 may include one or more output devices, such as a display 906 (e.g., an external television), and may include one or more output device controllers 907, such as a video processor. There may also be one or more user input devices 908, such as a remote control, keyboard, mouse, touch screen, microphone, etc. The computing device 900 may also include one or more network interfaces, such as a network input/output (I/O) circuit 909 (e.g., a network card, wireless transceiver, etc.) to communicate with an external network 910. The network input/output circuit 909 may be a wired interface, wireless interface, or a combination of the two. In some embodiments, the network input/output circuit 909 may include a modem (e.g., a cable modem), and the external network 910 may include the communication link 101, the external network 109, an in-home network, a wireless, coaxial, fiber, or hybrid fiber/coaxial distribution system (e.g., a DOCSIS network), or other network.

The FIG. 9 hardware configuration is one example. Modifications may be made to add, remove, combine, divide, etc. components of the computing device 900 into different arrangements. Additionally, the same components (e.g., processor 901, ROM storage 902, display 906, etc.) may be used to implement any of the other computing devices and components described herein. For example, the various components herein may be implemented using computing devices having components such as a processor executing computer-executable instructions stored on a computer-readable medium, as illustrated in FIG. 9. Some or all of the components described herein may be a combination of hardware and software, and may co-exist in a common physical platform (e.g., a requesting entity can be a separate software process and program from the requesting entity, both of which may be executed as software on a common computing device).

One or more aspects of the disclosure may be embodied in computer-usable data and/or computer-executable instructions, such as in one or more program modules, executed by one or more computers or other devices. Program modules may include routines, programs, objects, components, data structures, etc. that perform particular tasks or implement particular data types when executed by a processor in a computer or other data processing device. The computer executable instructions may be stored on one or more computer readable media such as a hard disk, optical disk, removable storage media, solid state memory, RAM, etc. In various embodiments, the functionality of the program modules may be combined or distributed across multiple computing devices. In addition, the functionality over the various embodiments described herein may be embodied in whole or in part in firmware or hardware equivalents such as integrated circuits, field programmable gate arrays (FPGA), and the like.

Although example embodiments are described above, the various features and steps may be combined, divided, omitted, and/or augmented in any desired manner, depending on the specific outcome and/or application. Various alterations, modifications, and improvements will readily occur to those skilled in art. Such alterations, modifications, and improvements as are made obvious by this disclosure are intended to be part of this description though not expressly stated herein, and are intended to be within the spirit and scope of the disclosure. Accordingly, the foregoing description is by way of example only, and not limiting. This patent is limited only as defined in the following claims and equivalents thereto.

We claim:

1. A method, comprising:
receiving, at a first computing device, an object model that comprises one or more objects;
traversing the object model such that each object is visited at least once; and
creating, based at least in part on the traversal, a document that represents the object model, wherein the document comprises an id for each object in the object model and a link between a first object and an id for a second object.

2. A method of claim 1, further comprising: sending the document to a second computing device in response to a hypermedia API method call.

3. A method of claim 1, wherein the document comprises an XHTML document with one or more tags.

4. A method of claim 1, wherein the document comprises a tag for each object in the object model.

5. A method of claim 4, wherein the link between the first object and the second object comprises a link between the tag for the first object and the id for the second object.

6. A method of claim 1, wherein the id for each object is a unique object id.

7. A method of claim 1, wherein the first object comprises a link to an id for the second object based on a reference between the first object and the second object in the object model.

8. A method of claim 1, wherein traversing the object model further comprises visiting each object once.

9. A method comprising:
receiving, at a first computing device, a document that represents an object model:
parsing the received document; and
creating, based on the parsed document, an object model that comprises one or more objects, wherein a reference is created between a first object and a second object.

10. A method of claim 9, wherein the received document comprises an XHTML document with one or more tags.

11. A method of claim 9, wherein the received document comprises a tag for each object in the object model.

12. A method of claim 11, wherein a link between a first object and a second object comprises a link between a tag for the first object and an id for the second object.

13. A method of claim 11, wherein the received document comprises a unique id for each object in the object model.

14. A method of claim 11, wherein the reference created between the first object and the second object is based on a link in the document between a tag for the first object and an id for the second object.

15. A method of claim 11, wherein the document is received in response to a hypermedia API method call.

16. One or more non-transitory computer readable media having stored thereon instructions that, when executed by an apparatus, cause the apparatus to:
receive an object model that comprises one or more objects;
traverse the object model such that each object is visited at least once; and
create, based on the traversal, a document that represents the object model, wherein the document comprises an id for each object in the object model and a link between a first object and an id for a second object.

17. The one or more non-transitory computer readable media of claim 16, wherein the document comprises a tag for each object in the object model.

18. The one or more non-transitory computer readable media of claim 17, wherein the link between the first object and the second object comprises a link between the tags for each object.

19. The one or more non-transitory computer readable media of claim 16, wherein the id for each object is a unique object id.

20. The one or more non-transitory computer readable media of claim 16, wherein the link between the first object and the second object comprises a link between the tag for the first object and the id for the second object.
